(19) United States
(12) Patent Application Publication
(10) Pub. No.: US 2008/0115474 A1
(43) Pub. Date: May 22, 2008

(54) Filter Insert

(75) Inventor: Daniel Volkmer, Dingolfing (DE)

Correspondence Address: GUDRUN E. HUCKETT DRAUDT, SCHUBERTSTR. 15A, WUPPERTAL, 42289, omitted

(73) Assignee: MANN+ HUMMEL GMBH, Ludwigsburg (DE)

(21) Appl. No.: 11/940,153

(22) Filed: Nov. 14, 2007

(30) Foreign Application Priority Data
Nov. 16, 2006 (DE) 20 2006 017 617.9

(51) Int. Cl. B01D 29/07

(52) U.S. Cl. 55/497

(57) ABSTRACT

A filter insert to be inserted seal-tightly into a filter housing has a filter element having opposite end faces. At least one of the opposite end faces is engaged by a reinforcement clamp. A sealing element is arranged on the reinforcement clamp, wherein the sealing element and the reinforcement clamp are independent, separate components. The sealing element has a central sealing element section and at least two outer sealing element sections connected to the central sealing element section. The central sealing element section is attached to a wall of the reinforcement clamp. The at least two outer sealing element sections are connected to the central sealing element section so as to be movable relative to the central sealing element section.

### BACKGROUND OF THE INVENTION

The invention relates to a filter insert that can be inserted preferably in a seal-tight way into a filter housing. The filter insert comprises a filter element having at least one end face that is engaged by a reinforcement clamp. A sealing element is disposed on the reinforcement clamp.

U.S. Pat. No. 6,045,598 discloses a filter insert comprising a folded or pleated filter that is insertable into a filter housing. The end faces of the folded or pleated filter are engaged or gripped by shape-stable clamp-shaped reinforcement elements provided with a unitary seal or gasket that is elastically pretensioned and can be placed seal-tightly against the adjoining housing wall of the filter housing. For a cost-effective manufacture, the reinforcement element and the seal are combined to a common component or module. Since the unitary reinforcement element and the integral seal are comprised of the same material and since it must be ensured that the seal can be elastically prestressed, a relatively soft and yielding material must be selected because, otherwise, the requirements in regard to seal-tightness cannot be realized.

### SUMMARY OF THE INVENTION

It is an object of the present invention to provide in a cost-efficient way by using simple constructive means a filter insert that can be seal-tightly inserted into a filter housing. According to a further aspect of the invention, expediently a radial as well as an axial sealing action is to be effected with simple means.

In accordance with the present invention, this is achieved in that the reinforcement clamp and the sealing element are separate components and the sealing element has at least two outer sealing element sections that are connected to one another by a central sealing element section that is connected to a wall of the reinforcement clamp wherein the outer sealing element sections are attached on the central sealing element section so as to be moveable relative thereto.

A reinforcement clamp is provided on the filter insert according to the invention which reinforcement clamp engages or grips the at least one end face of the filter element that is a component of the filter insert. The sealing element is configured as an independent component separate from the reinforcement clamp and is disposed on the reinforcement clamp. This sealing element has two outer sealing element sections that are connected to one another by means of a central sealing element section that is attached to the wall of the reinforcement clamp. The outer sealing element sections are connected to the central sealing element section so as to be moveable relative to the central sealing element section and therefore can perform a relative movement relative to the central sealing element. In this way, it is possible that the outer sealing element sections, when being transferred from the unloaded rest position into a sealing position, change their relative position relative to the central sealing element section without the connection between the central sealing element section and the wall section of the reinforcement clamp being impaired by this relative movement. In particular, the outer sealing element sections are moveable independent from one another so that each outer sealing element section, independent of the movement of the oppositely positioned sealing element section, can move from a rest position into a sealing position and vice versa. As a result of their connection to a common central sealing element section, despite their ability to move independently, a constructively simple seal is realized that can be mounted easily and can be adapted to the respective constructive conditions with minimal expenditure.

In an expedient further embodiment it is provided that a first one of the outer sealing element sections extends past the axial end face of the reinforcement clamp and the second external sealing element section is located laterally on the wall of the reinforcement clamp so that a sealing action at the end face, i.e., in the axial direction, as well as in the radial direction is enabled. In this connection, the sealing element extends expediently across the entire length of the reinforcement clamp.

The reinforcement clamp is advantageously a U-shaped component that engages or clamps an end face of the filter element; the filter element is expediently a pleated filter made from non-woven or paper or a paper-like material of natural or synthetic origin. Such filter elements are used in particular in air filters, for example, for internal combustion engines, or in liquid filters, for example, for oil or fuel.

Because of the inventive configuration comprising separate components, the reinforcement clamp and the sealing element can be manufactured of different materials that are best suited for the respective application of the component in question. For example, the sealing element is expediently embodied as a foam material strip.

In order to improve the relative movability between the outer sealing element section and the central sealing element section, the transitional area between these two sealing element sections can be provided with a predetermined bending location within the sealing element body: this ensures a defined bending behavior when the outer sealing element section is loaded when brought into the sealing position. The predetermined bending location, for example, is a tapered wall section in the sealing element body or is an impression that facilitates bending.

The central sealing element section of the sealing element can be injection-molded to a wall of the reinforcement clamp or the sealing element can be glued with its central sealing element section to the wall of the reinforcement clamp. Both embodiments can be realized with simple measures and ensure a sufficiently safe connection between reinforcement clamp and the sealing element. Other connecting types, for example, mechanical connections such as clamping, screwing or the like, are also conceivable.

### BRIEF DESCRIPTION OF THE DRAWING

FIG. 1 is a section view of a filter insert that is sealed-tightly inserted into a filter housing and is provided with reinforcement elements arranged at the end faces that engage the terminal fold of the filter element configured as a pleated filter, wherein on the outer wall of the reinforcement clamp a sealing element is arranged by means of which a flow-tight connection between the filter insert and the surrounding filter housing is provided.

FIG. 2 shows a detail section view of the reinforcement clamp with the sealing element that is comprised of a central sealing element section by means of which the sealing element is connected to the reinforcement clamp as well as two outer sealing element sections that are movable (bendable) relative to the central sealing element section.

FIG. 3 is an illustration corresponding to that of FIG. 2 with the lateral outer sealing element section of the sealing element shown in an angled position relative to the central sealing element section.

### DESCRIPTION OF THE PREFERRED EMBODIMENTS

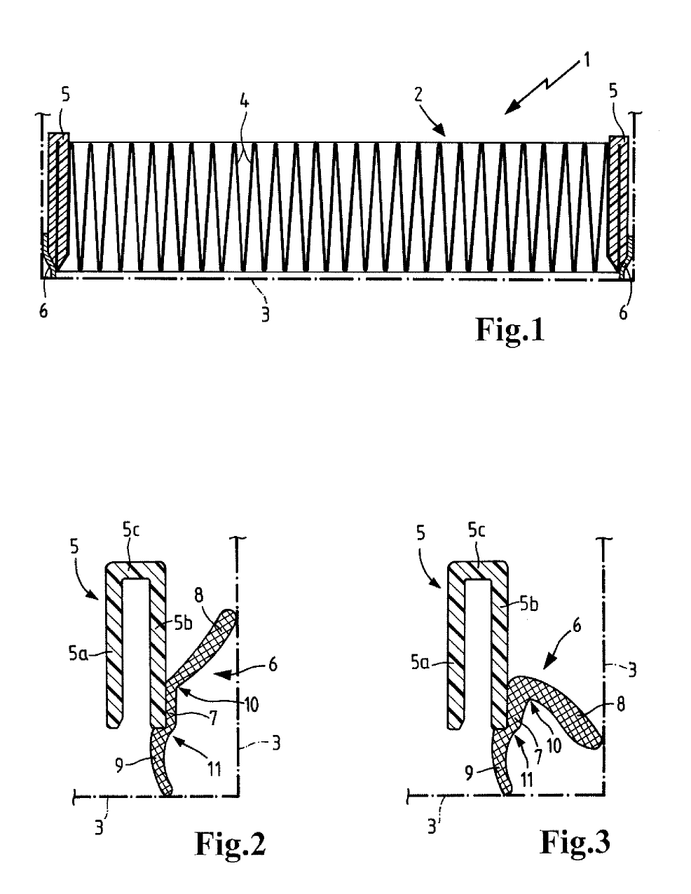

The filter illustrated in FIG. 1, for example, a gas filter, particularly an air filter, or a liquid filter, such as an oil filter or fuel filter, comprises a filter insert 2 that is inserted seal-tightly into the filter housing 3 of the filter. The filter insert 2 is comprised of a filter element 4 configured as a folded or pleated filter and of reinforcement clamps 5 that engage or clamp terminal folds of the folded filter. On the outwardly positioned wall of each reinforcement claim 5 a sealing element 6 is arranged that ensures seal-tightness between the filter insert 2 and the filter housing 3 receiving the insert 2. The sealing element 6 is an independent component, i.e., is separate from the reinforcement clamp 5, but is connected flexibly to the reinforcement clamp 5, particularly by gluing or by injection molding.

As can be seen in the enlarged illustration according to FIG. 2, the reinforcement clamp 5 is U-shaped and comprises two sidewalls 5a and 5b as well as a connecting web 5c so that a groove is formed in the reinforcement clamp 5 for receiving the terminal fold of the filter element. On the radially outwardly positioned wall 5b of the reinforcement clamp the sealing element 6 is provided that is of a three-part configuration comprising the central sealing element section 7 and two outer sealing element sections 8 and 9 connected to the central sealing element section 7; the sealing elements sections 7, 8, 9 form a monolithic part. The central sealing element section 7 is connected fixedly to the outer side of the radial outer sidewall 5b while the outer sealing element sections 8 and 9 are movable (bendable) relative to the central sealing element section 7; in particular, they can pivot relative to the central sealing element section 7. The first outer sealing element section 8 extends radially outwardly away from the sidewall 5b, the outer sealing element section 9 extends however away from the axial end face of the sidewall 5b. The free end faces of the outer sealing element sections 8 and 9 in their sealing position, which is identical to the mounted position of the filter insert 2, contact the inner wall of the filter housing 3 wherein the lateral outer sealing element section 8 rests against the correlated lateral wall of the housing and the axially projecting outer sealing element section 9 rests against the correlated axial inner wall of the filter housing.

As can be seen in particular when comparing FIGS. 2 and 3, the outer sealing element sections 8 and 9 can pivot relative to the central sealing element section 7. This pivoting action is enabled on the one hand in that the central sealing element section 7 is connected by the entire surface area facing the reinforcement clamp 5 to the outwardly facing sidewall 5b of the reinforcement clamp 5, particularly by being glued thereto or by being injecton-molded thereto; the outer sealing element sections 8 and 9, on the other hand, have no direct connection to the reinforcement clamp 5. The pivoting action is enhanced and improved also in that at the location where the central sealing element section 7 passes into the two outer sealing element sections 8 and 9, a predetermined bending location 10, 11 is provided, respectively, in the sealing element body of the sealing element. The bending locations 10, 11 are produced by a constriction, a tapered section or the like. In this way, a defined bending behavior of the outer sealing element sections 8, 9 relative to the central sealing element section 7 is achieved so that even for frequent usage a defined contacting of the sealing element on the filter housing in the sealing position is ensured.

The specification incorporates by reference the entire disclosure of German priority document 20 2006 017 617.9 having a filing date of Nov. 16, 2006.

While specific embodiments of the invention have been shown and described in detail to illustrate the inventive principles, it will be understood that the invention may be embodied otherwise without departing from such principles.

What is claimed is:

1. A filter insert to be inserted seal-tightly into a filter housing, the filter insert comprising:
a filter element having opposite end faces;
at least one of the opposite end faces engaged by a reinforcement clamp;
a sealing element arranged on the reinforcement clamp, wherein the sealing element and the reinforcement clamp are independent, separate components;
wherein the sealing element has a central sealing element section and at least two outer sealing element sections connected to the central sealing element section;
wherein the central sealing element section is attached to a wall of the reinforcement clamp;
wherein the at least two outer sealing element sections are connected to the central sealing element section so as to be movable relative to the central sealing element section.

2. The filter insert according to claim 1, wherein a first one of the at least two outer sealing element sections is located laterally on the wall of the reinforcement clamp.

3. The filter insert according to claim 2, wherein a second one of the at least two outer sealing element sections extends axially away from an end face of the wall of the reinforcement damp.

4. The filter insert according to claim 1, wherein one of the at least two outer sealing element sections extends axially away from an end face of the wall of the reinforcement clamp.

5. The filter insert according to claim 1, wherein at least one transitional area between the central sealing element section and the at least two outer sealing element sections, respectively, is provided with a predetermined bending location.

6. The filter insert according to claim 1, wherein the sealing element is injection-molded onto the reinforcement element.

7. The filter insert according to claim 1, wherein the sealing element is glued onto the reinforcement element.

8. The filter insert according to claim 1, wherein the filter element is a pleated filter.

9. The filter insert according to claim 1, wherein the opposite end faces of the filter element each are engaged by one of said reinforcement clamp provided with said sealing element.

10. The filter insert according to claim 1, wherein the sealing element is a foam material strip.
